(19) United States
(12) Patent Application Publication
(10) Pub. No.: US 2017/0158030 A1
(43) Pub. Date: Jun. 8, 2017

(54) Windshield Guard

(71) Applicant: Sam Osta, Citra, FL (US)

(72) Inventor: Sam Osta, Citra, FL (US)

(21) Appl. No.: 15/370,691

(22) Filed: Dec. 6, 2016

Related U.S. Application Data
(60) Provisional application No. 62/264,521, filed on Dec. 8, 2015.

(51) Int. Cl. B60J 1/20; H02J 7/14; H02J 7/00; B60S 3/04

(52) U.S. Cl. CPC B60J 1/2011; B60J 1/2091; B60S 3/04; H02J 7/14; H02J 7/0045

(57) ABSTRACT

The present invention provides for several embodiments of a multi-purpose windshield sun reflector and windshield heater, including embodiments which provide for a retractable, easy to set up, variable temperature windshield guard. The inventive windshield guard fan be used during the warm months or the cold months and includes at least a sleeve containing at least one heating element and a plug or plug and chord assembly for providing power to the heating elements. The windshield guard is intended to blanket along the inside of a windshield. The present invention further provides for a rollable windshield guard which includes heating elements internal to a sleeve of material, and a power chord for supplying power to the heating elements. The sleeve is made of materials that would alternatively, depending on the intended use, reflect or absorb sunlight while providing an optional heat source to prevent or remove ice formation on the windshield.

### CROSS-REFERENCE TO RELATED APPLICATION

This application claims the benefit of U.S. Provisional Application No. 62/264,521, having a filing date of Dec. 8, 2015, the disclosure of which is hereby incorporated by reference in its entirety and all commonly owned.

### FIELD OF INVENTION

The present invention relates to windshield visors. More particularly, the present invention relates to a windshield visor which blocks sunlight from heating a parked vehicle and optionally provides a heat source to melt or prevent accumulation of snow and ice on a windshield in the winter.

### BACKGROUND

Many automobile owners recognize the need to protect their vehicle from the sun. Exposure to sunlight is a major cause of damage to the interior of an automobile. The ultraviolet radiation from the sun can build up inside your vehicle leading to costly maintenance and repairs. A vehicle's interior upholstery is especially prone to discoloration and fading. Leather can quickly age in the sun, long term exposure can even dry out the natural oils in the leather causing leather to stiffen and crack. The car's dashboard experiences some of the longest exposure to the sun, the heat from which is intensified by the glass of the windshield. This exposure can quickly cause discoloration of your dashboard. Additionally, vehicle occupant comfort is another consideration when dealing with sun exposure of a vehicle. In order to combat these issues, several attempts have been made in sun guards to protect your vehicle. The attempts fall into two categories; inside and outside sun guards.

Visors are widely used to limit the amount of heat entering into a vehicle while parked, to help reduce the peak inside temperature that the car may reach. This assists with comfort of a vehicle occupant immediately after getting into a parked vehicle, and also reduces the time for the vehicle's air conditioning to bring the overall car temperature to a bearable temperature. The prior art includes several types of sun guards that may be placed inside the vehicle. Among the protective inside covers there exists one size fits all, customizable, foldable, roll-able, reflective, flexible fabric covers, rigid venetian blind like covers and more. The inside guard options are vast, but have many shortcomings that do not make them the preferred solution. Most importantly is the issue that none of the inside covers protect against winter elements including snow and ice, they only guard against the sun. Additionally many of the guards are bulky and cumbersome or made of rigid inflexible materials.

Outside vehicle covers provide a better solution for the snow and the ice, but fall short of preventing buildup of snow and frost on your windshield in the first place. The external covers offered require you to combat the snow that collects on top of these covers. Depending on the amount of snowfall, and the age or health of a person, external covers may be particularly challenging to remove the snow and ice from. While these external covers can more effectively protect against the sun than the inside covers they are apt to cause discoloration to the outside of your vehicle, and cause variations in your paint job where the material covering the windshield meets the paint job of your vehicle. In addition, external covers are cumbersome to use in a crowded parking lot or in the event of a large vehicle anywhere but at your own home.

Guards offered in both of these main categories fall short of meeting a vehicle owner's true needs. Inside solutions provide a sun guard that is ineffective regarding the winter elements. Outside solutions provide a guard that is more helpful yet still does not solve the problem of dealing with large amounts of snow and exterior paint discoloration. Moreover the outside covers require you to set them up on your car windshield prior to any snowfall. Oftentimes it will snow when least expected or it will be too cold to go outside or inconvenient to rush out to set up the external guard. In addition, many of these guards are bulky and prevent the guard from being easily set up and portable. Furthermore, no guard thus far can do what the inside and outside guards do combined. Some solutions protect your vehicle from the sun, some solutions protect your vehicle from the snow, no solution allows you to protect your vehicle from both the sun and snow, while not requiring any snow removal from the windshield on the part of the vehicle owner.

While it is appreciated that some attempts offer sun protection and others snow protection, nothing offers an inside guard capable of protecting your vehicle from the sun, that also melts snow, frost and ice from the windshield that as has already accumulated, and that can prevent snow and ice from forming to begin with. There is no guard that can protect a vehicle against all of the elements, and that requires little to no effort from the vehicle owner. Thus there remains a need for a retractable easy to set up, variable temperature windshield guard. No guards exist which: are portable; easy to set up; flexible; protect from the sun; melt snow and ice; prevent snow and ice from forming; and can be plugged into a vehicle 12 volt DC receptacle. Thus, there remains an unmet need.

### SUMMARY

The present invention provides for several embodiments of a multi-purpose windshield sun reflector and windshield heater, including embodiments which provide for a retractable, easy to set up, variable temperature windshield guard. The inventive windshield guard fan be used during the warm months or the cold months and includes at least a sleeve containing at least one heating element and a plug or plug and chord assembly for providing power to the heating elements. The windshield guard is intended to blanket along the inside of a windshield

The present invention further provides for a rollable windshield guard which includes heating elements internal to a sleeve of material, and a power chord for supplying power to the heating elements. The sleeve is made of materials that would alternatively, depending on the intended use, reflect or absorb sunlight while further providing an optional heat source to prevent ice formation, or to remove ice, on the windshield.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 is a front perspective view of the inventive 10 windshield guard illustrating a 100 sleeve and a 400 power plug. Certain embodiments include a 200 housing unit, and a 300 retraction assembly.

FIG. 2 is a front perspective view of the 10 windshield guard illustrating a 100 sleeve and a 400 power plug. Certain embodiments further include a 200 housing unit, and a 300 retraction assembly as seen in FIG. 2. The 100 sleeve is further comprised of heating elements which may be at the edges of the sleeve, or be ubiquitously internal throughout the sleeve. The heating elements receive power to heat a windshield from the 400 power plug. In at least one embodiment the 400 power plug includes a 401 wire and a 402 plug that connects to a 12 volt DC receptacle.

FIG. 3 is a front perspective view of the 10 windshield guard illustrating a 100 sleeve and a 400 power plug. FIG. 3 shows the top of the 401 power chord. In certain embodiments the 100 sleeve is further comprised of a plurality of 500 heating elements ubiquitous within and running the length of the 100 sleeve, which receive power to heat a windshield from the 400 power plug.

FIG. 4 is a perspective view of the windshield guard in use with the windshield of the vehicle illustrating the 100 sleeve in contact with the 401 power chord of the power plug. The 100 sleeve is further comprised of a plurality of 500 heating elements ubiquitous within and running the length of the 100 sleeve, as illustrated in FIG. 3.

### DETAILED DESCRIPTION

The following detailed description is merely exemplary in nature and is in no way intended to limit the scope of the invention, its application, or uses, which may vary. The invention is described with relation to the non-limiting definitions and terminology included herein. These definitions and terminology are not designed to function as a limitation on the scope or practice of the invention, but are presented for illustrative and descriptive purposes only.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

### Generally

The present invention contains the features of an inventive windshield guard for protecting a vehicle from the sun, snow, ice and other elements. The inventive windshield guard includes a sleeve with heating elements, and a power plug for providing power to the heating elements when being used as a windshield defroster. In other embodiments the inventive windshield guard includes a sleeve, at least one housing unit, at least one retraction assembly and a power plug.

While it is intended that the inventive windshield guard be light weight in order to be portable, easy to put up and take down, and easy to pack and store, the inventive windshield guard can be made of many materials. Without limiting the invention to any particular material, it is appreciated that many materials are known in the art which may be lightweight or flexible in order to accomplish the purpose of the intention. In at least one embodiment the housing unit, retraction assembly and sleeve are made of a carbon fiber fabric, polyethylene, polyamide fabric, silicon, or combinations thereof. Without intending to limit the invention, the inventive windshield guard may be made to accommodate any size window or windshield. In some embodiments the windshield guard is as small as 20″ tall, up to 50″ tall and as short as 30″ long or up to 80″ long to accommodate anything from a smart car to a Mack truck. In some embodiments, the windshield guard may be manually rolled up, folded up, retracted like an accordion, rolled into a house, disassembled and stored, or combinations thereof. In other embodiments, the windshield guard may be automatically rolled up. It should be further appreciated that while the windshield is one concern, the inventive guard may also be adapted to the rear window or side windows of the vehicle.

It is appreciated that particularly in colder climates snow and ice build-up on vehicles is a real issue. Automobile owners can spend prolonged periods of time cleaning off a vehicle after a storm. Windshields are particularly prone to ice build-up due to the angle of the glass. Having to scrape thick ice off a windshield in the cold can be particularly challenging for the elderly. The inventive windshield guard is a far easier solution, whereby the owner can simply plug in the assembled guard and allow the guard to do all the work.

### Sleeve

The sleeve of the inventive guard is intended to provide a sun shield when being used in the windshield to block the sun, while simultaneously holding heating elements for use of the windshield guard in the winter. In one embodiment where the heating elements consist of two bars, one on the left and one on the right side of the guard. The sleeve allows for the heat to be trapped between the windshield and the sleeve and dispersed throughout the area in which the sleeve is located.

In at least one embodiment the heating element runs along the top and bottom edges of the sleeve.

In at least one embodiment, the heating element may be coiled within the length of the sleeve. In one embodiment where the heating elements consist of a plurality of heating elements, evenly spaced, internal to, and ubiquitously throughout the sleeve as seen in FIG. 3. The sleeve facilitates the dispersion of heat over the surface of the windshield. It is appreciated that the heating element within the sleeve can be any of these embodiments, or be contained in a single embodiment.

The sleeve in intended to provide a large surface through which a) the sun may be adequately shielded from the interior of the vehicle, and b) the heating elements may be dispersed and travel throughout. In some embodiments the sleeve can attach directly to the windshield, permitting heat to transfer throughout the sleeve, or under the sleeve, to all portions of the windshield, thereby preventing the build-up of ice or snow on the windshield. If snow or ice has accumulated on the windshield when the guard was not being used, once the guard is plugged in, the heating elements will warm the sleeve causing the ice and snow build-up to melt.

In at least one embodiment the sleeve consists of a strong carbon fiber material. In at least one embodiment the carbon fiber material are made from polyacrylonitrile; rayon, petroleum pitch, or combinations thereof, bonded by carbon atoms. The carbon fiber material is particularly electrically conductive, allowing the heat coming from the heating elements to quickly disperse throughout all portions of the sleeve.

In at least one embodiment the sleeve consists of a silicone material. The silicone material attaches directly to the windshield. The direct adhesion of the sleeve to the windshield allows the heat coming from the heating elements to reach all portions of the sleeve attached to the windshield and melt snow and ice quickly. In at least one embodiment the silicone sleeve may allow the guard to be rolled up and easily taken down.

In some embodiments the sleeve may be additionally paired with or fastened to a material that blocks the sun from entering the vehicle, such as a reflective fabric. In at least one embodiment, the inventive sleeve includes a sun light reflective material on one side of the sleeve, and a sunlight absorbing material on the other side of the sleeve.

### Housing Unit

The housing unit, where used, serves the function of enclosing the sleeve and anchoring the guard to the surface of the windshield. In at least one embodiment, the housing unit is used with a retraction assembly so that the sleeve may be rolled within the housing unit when not in use, or may be extracted using a retraction handle. It is appreciated that the housing unit, when used, may be comprised of a variety of materials including plastic, flexible fabric material, fiberglass rods, polyester rods, mylar, or combinations thereof.

### Power Plug

The power plug is intended to be used to energize the heating elements, when desired, within the sleeve. It is appreciated that many power plugs exist, and nothing herein shall be intended to limit the plug adapter type. It is appreciated that different countries use different standards of power plugs for home and vehicle uses. Any power plug known in the art may be adapted to energize the heating elements. In at least one embodiment, the power plug is a DC plug to be adapted to a power source within a vehicle.

Depending on the embodiment used, the power plug may either be connected to the sleeve or to a connector of the housing. In embodiments without a housing, the power plug is connected to the sleeve at a terminal to distribute power from the power plug to the heating elements. In an alternative embodiment the power plug may not connect to the 12 volt DC receptacle but instead directly to the vehicle battery.

### Retraction Assembly

The retraction assembly of the inventive guard is connected to the sleeve and housing unit and is intended to retract the sleeve within the housing unit. Without intending to limit the invention, it is intended that the retraction assembly is connected to the housing unit and sleeve to provide the user with a convenient means to extract and retract the windshield guard. In at least one embodiment the retraction assembly is designed to retract the entire length of the sleeve in one direction. In an alternative embodiment at least two retraction assemblies with at least two housings are used to retract both ends of the sleeve simultaneously, thus allowing for a smaller housing to prevent obstruction.

### Heating Elements

The heating element is intended to be used to disperse heat, when desired, within the sleeve. In at least one embodiment the heating element is comprised of a multi strand resistance wire or fabric mesh such has FabRoc or ThermoKnitt, or combinations thereof. Such heating elements allow for a uniform distribution of heat throughout the sleeve. In at least one embodiment the heating element may consist of two wires that run the horizontal length of the sleeve. In other embodiments the heating element may consist of two vertical bars on the sides of the windshield guard. In alternate embodiments the heating element may run sporadically throughout the sleeve. The use of this material is a surprising result. First, the wire or mesh heating elements require very little power, thus the concern of draining a user's battery is thus relieved, since several hours of operation of the windshield guard can occur, when be used for deicing a windshield, without affecting the ability of the car to start as a result of a drained battery. Moreover, this is further a surprising result, because these types of heating elements further allow for the windshield guard to be rolled without compromising the integrity of the windshield guard. Finally the wire or mesh heating elements coupled with a silicon sleeve material provides an additional surprising benefit as heat is retained in the sleeve, thus providing a longer lasting heat cycle, and requiring less amount of energy to maintain the ice melted.

### EXAMPLES

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

### Example 1

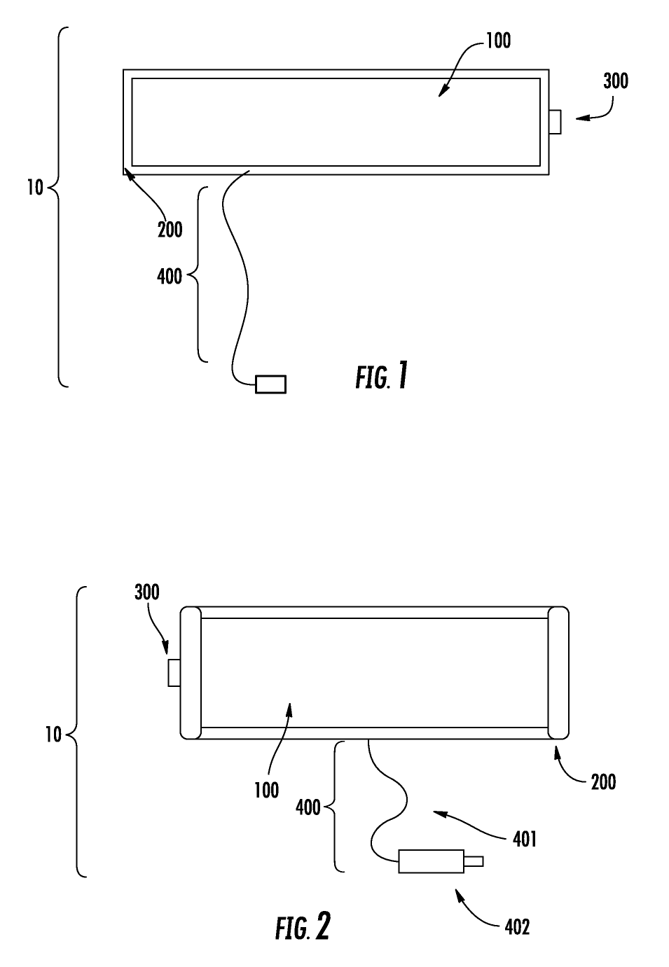

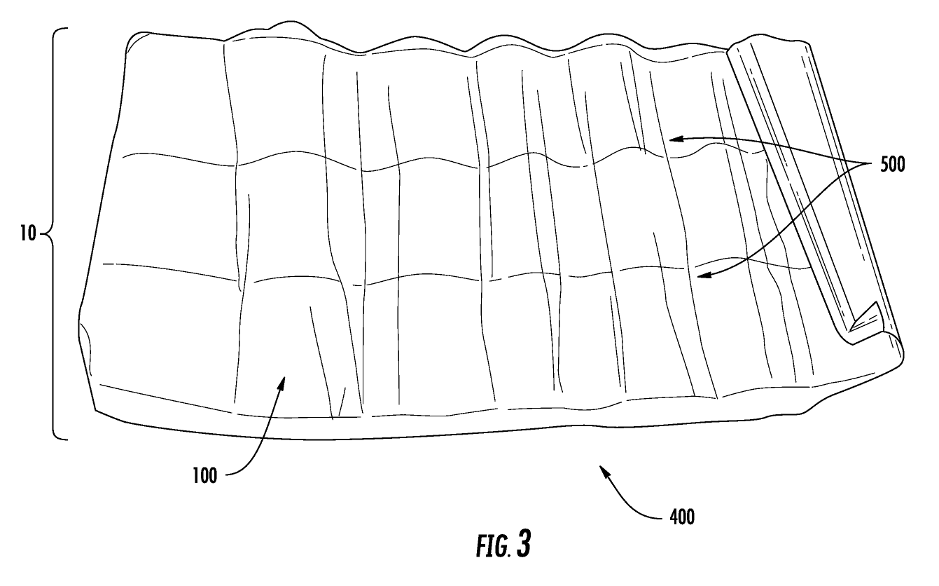

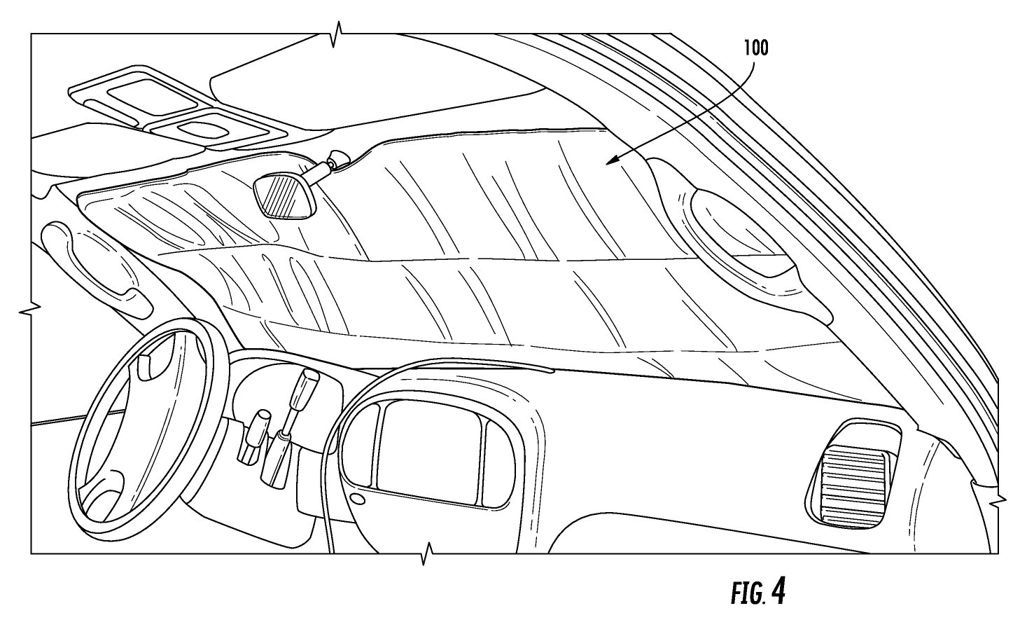

A windshield guard of FIG. 1, FIG. 2, and FIG. 3 is used to block the sun from degrading the interior of a vehicle during the hot times of the year and to melt, and prevent the build-up of snow and ice on vehicle windshields during the cold times of the year. The windshield guard is installed in the vehicle according to FIG. 4. The 10 windshield guard includes a 100 sleeve, which extends the entire length of a windshield. The heating elements are dispersed throughout the internal length of the sleeve allowing for an even heating across the sleeve. The 400 power plug is connected to the heating elements within the sleeve. The 100 sleeve is made of carbon fiber and attaches directly to the windshield. When not in use the user manually rolls up the sleeve and stores on the floor or in the trunk of the vehicle.

### Example 2

The windshield guard has a 100 sleeve that encompasses the 500 heating elements on the left and right side of the sleeve only. FIG. 1 and FIG. 2 illustrate bars which include the location of one or more of the heating elements. The 500 heating elements warm the 100 sleeve so that heat disperses through the 100 sleeve. For this example the 200 housing using and 300 retraction assembly of FIG. 2 are included as part of the 10 windshield guard. The 200 housing unit holds the 100 sleeve when rolled up and not in use. The 300 retraction assembly allows the user to fold up the guard into a smaller unit.

### Other Embodiments

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

1. A windshield visor or guard for reducing the heat internal to a vehicle caused by the sun, or for use to remove or prevent ice from forming on a windshield, the guard comprising:
a sleeve; and
at least one heating element;
said heating element contained within and throughout the sleeve, or along one or more edges of the sleeve.

2. The guard of claim 1 wherein said sleeve is made of polyethylene, polyamide fabric, silicon, or combinations thereof.

3. The guard of claim 2 wherein the sleeve is made of a carbon fiber fabric with a silicon coating.

4. The guard of any of claim 1 further comprising a power plug for energizing said heating element.

5. The guard of claim 4, wherein said power plug connects to a 12 volt DC receptacle.

6. The guard of claim 1 further comprising at least one housing assembly for housing the sleeve and heating elements when not in use.

7. The guard of claim 6 further comprising at least one retraction assembly to assist retracting the sleeve internal to the at least one housing assembly.

8. The guard of claim 6 comprising of at least two housing assemblies and at least two retraction assemblies.

9. A rollable, variable temperature windshield guard, the guard comprising:
at least one heating element;
a sleeve, said heating element contained within and throughout the sleeve, or along one or more edges of the sleeve; and
at least one housing assembly;
wherein said sleeve and heating element are stored in the housing assembly when not in use.

10. The guard of claim 9 wherein said sleeve is made of a carbon fiber fabric.

11. The guard of claim 9 further comprising a power plug for energizing said heating element.

12. The guard of claim 11 wherein said power plug connects to a 12 volt DC receptacle.

13. The guard of claim 9 wherein said heating element is made of multi strand resistance wire.
